(19) United States
(12) Patent Application Publication
(10) Pub. No.: US 2019/0292810 A1
(43) Pub. Date: Sep. 26, 2019

(54) OPTICAL SHIELD FOR KEYPAD LOCKS

(71) Applicant: OJMAR, S.A., Elgoibar - Guipuzcoa (ES)

(72) Inventors: Joseba Jokin AGUIRREZABALA OLASAGASTI, Elgoibar - Gipuzkoa (ES); Jon ZABALA ZABALETA, Elgoibar - Gipuzkoa (ES)

(21) Appl. No.: 16/361,903

(22) Filed: Mar. 22, 2019

(30) Foreign Application Priority Data
Mar. 23, 2018 (ES) P201830289

(51) Int. Cl. E05B 9/00; E05B 17/22

(52) U.S. Cl. CPC E05B 9/002; E05B 2009/004; E05B 17/22

(57) ABSTRACT

An optical shield for keypad locks that has a frame provided with one or several structures into which standard structures (C1) fit that the lock keypads (C) have; one or several side panels that project from the frame body impeding the lateral view of the keypad of the lock (C) from an area near the user who is operating it; and means to fasten indirectly the frame to the lock module/keypad (C), without interfering in it. It can also have an additional panel, mounted on the frame and capable of sliding linearly in it, and provided with a window through which one can access a restricted area of the keypad, impeding the frontal view of the rest.

### CROSS REFERENCE TO RELATED APPLICATION

This Application claims priority of Spanish Application No. P201830289 filed Mar. 23, 2018, which is incorporated herein by reference.

### PURPOSE OF THE INVENTION

The purpose of the invention is an optical shield for keypad locks, used to prevent, impede or obstruct third parties from seeing the lock's code while the user is operating it.

### BACKGROUND OF THE INVENTION

In the current state of the art, locks (normally electronic locks) that use a keypad instead of a key are well known, being able to cite, for example and among others, the preceding documents EP1049843, EP1486632 and ES2555675.

In more recent technology, the applicant is the owner of the preceding document WO2017068211, referring to an electronic lock with keypad for furniture, cabinets or lockers.

### TECHNICAL PROBLEM TO SOLVE

An unresolved problem in this type of locks resides in the fact that, while the user is operating the keypad, security is completely violated if a third party sees the correct combination of the keys that opens the lock.

This problem is even more serious when the keypad lock is used in public places (for example, entry doors of a multi-dwelling building or lockers of the public transportation stations, schools, gyms, swimming pools, and similar); and when the locks are already mounted and being used, since the solution cannot involve any change, alteration or modification to the lock itself or to the surrounding area (access door or frame, locker or furniture) where it is being used.

### DESCRIPTION OF THE INVENTION

The purpose of the invention is an optical shield that, mounted on the lock itself (when it is, in turn, mounted and functioning in its operative site), consists of a solution to prevent, impede or obstruct optical access to the lock's keypad while the user is using it. It is characterised in that it consists of, at least, a frame provided in one or several structures in which the standard keypad structures fit; one or several side panels that project from the body of the frame impeding the lateral and/or vertical view of the lock from an area next to the user; and the means to indirectly fasten the frame to the module/keypad of the lock, without interfering with it.

Any alternative realisations that do not alter, change or modify the proposed essential nature are included in the purpose of the invention. Particularly,
the cited structures for mounting the shield on the lock or its keypad have grooves made on the back of the shield, situated in pairs and provided with some openings on one of its ends in order to position in them the cited standard structures of the lock or its keypad;
the cited means for indirectly fastening the frame of the lock or its keypad are, at least, a plate fastened to the frame closing the structure, in order to impede its accidental or malicious removal;
it has an additional panel mounted on the frame which can slide linearly; with this panel being provided with, at least, a window through which a restricted area of the keypad is accessed, impeding the frontal view of the rest.

Other configurations and advantages of the invention can be deduced from the following description, and from the dependent claims.

### DESCRIPTION OF THE DRAWINGS

For a better understanding of the purpose of the invention, the attached drawings represent a preferred realisation, susceptible to changes of accessories that do not undermine its purpose. In this case:

FIG. 1a represents a general schematic view of the shield that is the subject of the invention as an example of its realization.

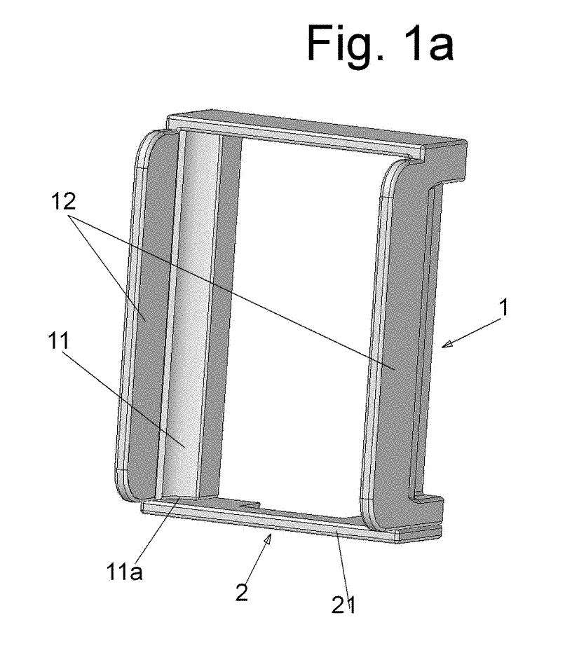

FIG. 1b represents a general schematic view similar to FIG. 1a, incorporated on a keypad lock (C).

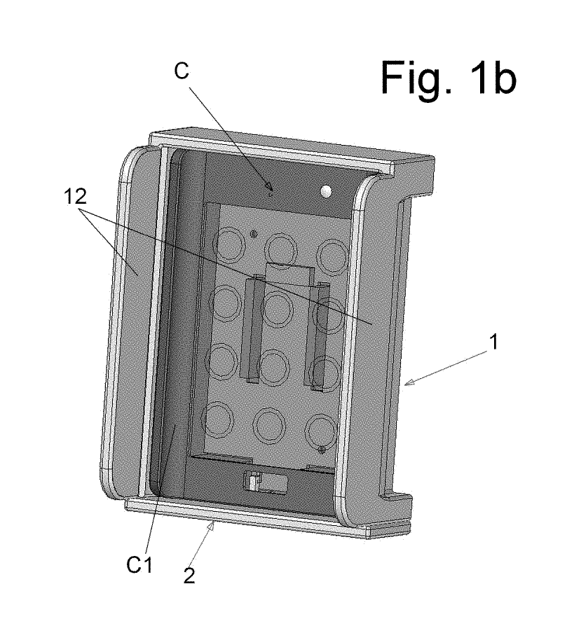

FIG. 2a represents a general schematic view of the shield that is the subject of the invention as an alternative example of its realization which includes an additional panel (3).

FIG. 2b represents a general schematic view similar to FIG. 2a, incorporated on a keypad lock (C).

FIG. 2c represents a general schematic view similar to FIG. 2a, with the basic components ready for assembly as an example of its realisation.

### DETAILED DESCRIPTION OF A PREFERRED REALISATION

An example of the practical realisation of this invention is described below, but not limited to it. Other modes of realisation would not be ruled out at all in which changes of accessories that do not undermine its purpose.

The purpose of the invention is an optical shield for keypad locks, which consists of, at least, a frame (1) with one or several side panels (12) that project from the frame body (1) impeding the lateral view of the keypad for the lock (C) from a location near the user who is operating it.

The cited frame (1) is provided with one or several structures (11) in which other standard structures (C1) fit, which keypads for locks (C) have as a series. The specific configuration/geometry of these structures (11), (C1), is indifferent for the effect of the invention and they can vary according to the different models/manufacturers existing in the market. It is basic for the effects of the invention that these structures fit different models without requiring any alteration in them, or in the lock or in its keypad (which are already installed and functioning).

According to the represented realisation, the cited structures (11) have vertical grooves made in the back of the frame (1), situated in pairs and provided with some openings (11a) in one of its ends. The cited standard structures (C1) are first placed at the opening (11a) and then they are slid down along the form (11) until finally the frame (1) is positioned in the area of the keypad so that the side panels (12) that project from the body of the frame (1) impede the lateral view of the keypad from an area next to the user who is operating it.

The cited frame (1) also has means (2) to fasten it indirectly to the lock module/keypad (C), without interfering with it.

For the represented realisation, the cited means (2) are, at least, a plate (21) fastened to the frame (1) closing the structures (11) to impede the accidental or malicious removal of the frame (1).

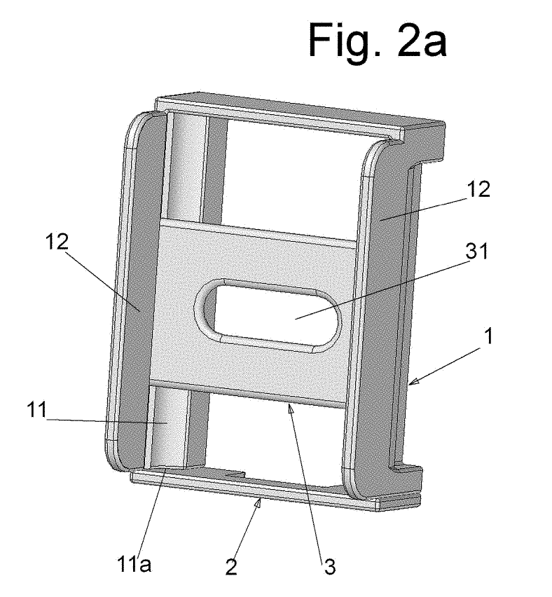

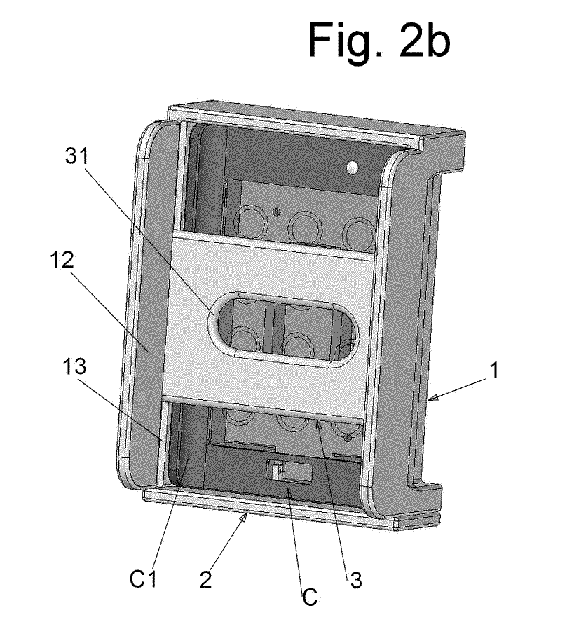

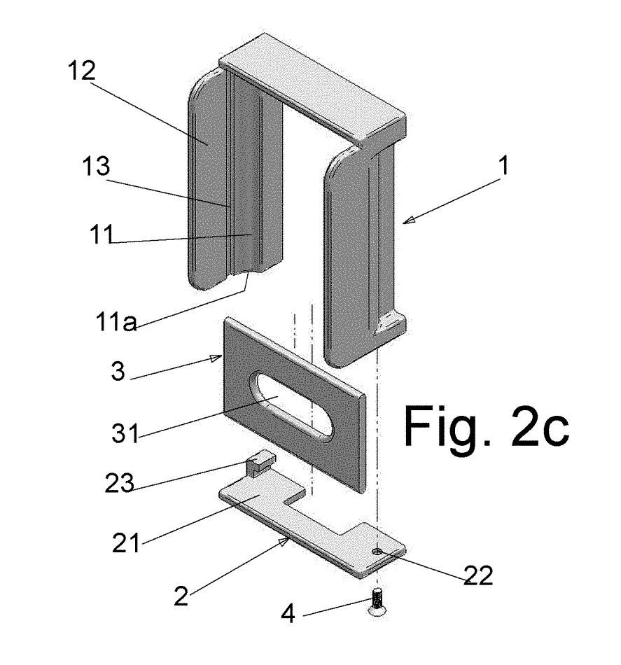

The mounting and fastening of the plate (21) in the frame (1) takes place, for example (see FIG. 2c), using a hole (22) lined up with another treaded blind hole made in the body of the frame (1); and having a tab (23) lined up with a recess made in the body of the frame (1). The fastening that impedes the undesired (accidental or malicious) removal of the shield that is the subject of the invention takes place inserting the tab (23) in the recess and inserting a safety screw (4) in the confronted holes.

The shield that is the subject of the invention, additionally, may have an additional panel (3) mounted on the frame (1) and is capable of sliding linearly in it. This additional panel (3) is provided with, at least, a window (31) through which one may access a restricted area of the keypad, impeding the frontal view of the rest.

For the represented realisation example, this additional panel (3) is placed in its guide rails (13) made in the body of the frame (1) and specifically in the base area of the side panels (12). Along these guide rails (13) the panel (3) slides at the will of the user so that its window (31) is in front of a restricted area of the lock keypad (C) impeding the frontal view of the rest; in such a way that it is practically impossible to discover which keys the user is pressing at each moment.

The materials, dimensions, proportions and, in general, those other accessory or secondary details may vary, as long as they do not alter, change or modify the proposed essential nature.

The terms in which this report is prepared are true and the faithful reflection of the described object, and should be taken in their broadest sense and never in a limiting manner.

1. Optical shield for keypad locks, comprising:
a frame comprising:
at least one structure into which standard structures fit which the lock keypads have; and
one or several side panels that project from the frame body impeding the lateral view of the lock keypad from an area near the user who is operating it; and
a means to fasten indirectly the frame to the lock module/keypad, without interfering with it.

2. A shield, according to claim 1, wherein the at least one structure comprises:
grooves made in on its back and provided with some openings in one of its ends in order to position the standard structures in it.

3. A shield, according to claim 1, wherein the means for indirectly fastening the frame to the lock are, at least, a plate fastened to the frame closing the structures to impede the accidental or malicious removal of the frame.

4. A shield, according to claim 1, comprising:
an additional panel mounted on the frame capable of sliding linearly in it and comprising at least, one window through which a restricted area of the keypad is accessed, impeding the frontal view of the rest.
